(19) United States
(12) Patent Application Publication
(10) Pub. No.: US 2013/0103960 A1
(43) Pub. Date: Apr. 25, 2013

(54) METHOD AND DEVICE WITH INTELLIGENT POWER MANAGEMENT

(71) Applicants: William P. Alberth, Prairie Grove, IL (US); Geoffrey S. Roman, New Hope, PA (US)

(72) Inventors: William P. Alberth, Prairie Grove, IL (US); Geoffrey S. Roman, New Hope, PA (US)

(73) Assignee: MOTOROLA MOBILITY, INC., Libertyville, IL (US)

(21) Appl. No.: 13/279,448

(22) Filed: Oct. 24, 2011

(51) Int. Cl. G06F 1/32; G06N 5/04; G08B 21/00

(52) U.S. Cl. 713/320; 340/636.1; 706/52

(57) ABSTRACT

A wireless communication device (200) and method (300) for improving a browsing experience. The method (300) can include: determining (310) an expected time to a next charge; providing (320) a program that correlates typical user usage and determined time to the next charge, to calculate if an energy storage device of a wireless communication device will last to the next charge; and prompting (330) a user with options to minimize power drain based on the calculation. The method (300) can increase the useful life of a battery. Users will embrace this feature because charging can be delayed.

### BACKGROUND

1. Field

The present disclosure relates to a method and device with intelligent power management.

2. Introduction

As background, many wireless communication devices, such as smart phones and tablets, can barely get through a day on a single charge with normal use. With high use, or if the user cannot charge a wireless communication device at the end of the day, then a user will be left with a dead battery (or energy storage device, these terms used interchangeably), resulting in a non-operational wireless communication device or phone, unable to receive calls, place calls, or help a user navigate in an unfamiliar city.

There is a need for methods and devices with intelligent power management, to for example, alert a device or user as to when to expect the next charge, so that a device can better manage power to maintain usefulness for a user.

There is a need for improving and managing battery life in electronic devices, such as wireless communication devices.

It would be considered an improvement in the art, if a wireless communication method and device with enhanced power management were developed.

There is yet a further need to provide an intelligent method and device adapted to provide personalized and reliable battery management information to a user.

Thus, a method and device with intelligent power management that addresses these needs, would be considered an improvement in the art.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a communication system according to one embodiment.

FIG. 2 is an exemplary block diagram of a wireless communication device with intelligent power management according to one embodiment.

FIG. 3 is an exemplary block diagram of a wireless communication method with intelligent power management according to one embodiment.

FIG. 4 is an exemplary block diagram of a wireless communication method with intelligent power management according to one embodiment.

### DETAILED DESCRIPTION

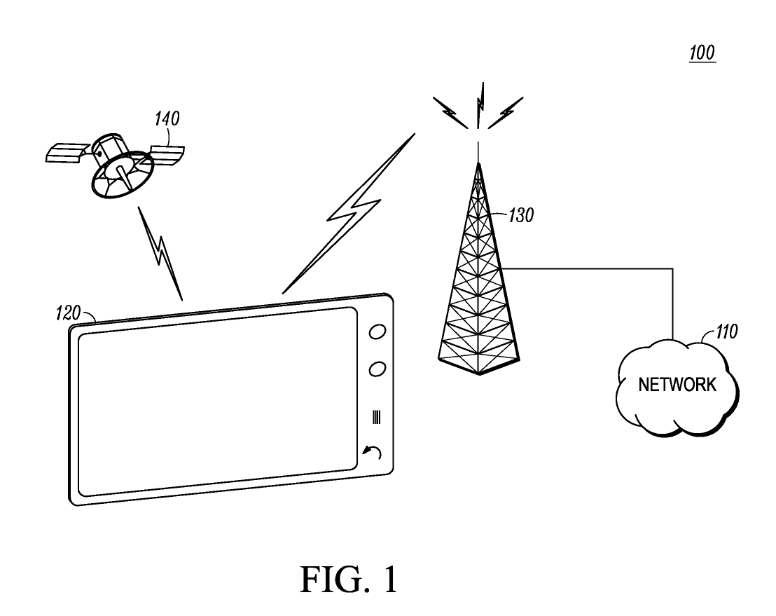

FIG. 1 is an exemplary block diagram of a system 100 according to one embodiment. The system 100 can include a network 110, a terminal 120, and a base station 130. The terminal 120 may be a wireless communication device, such as a wireless telephone, a cellular telephone, a personal digital assistant, a pager, a personal computer, a tablet, a selective call receiver, or any other device that is capable of sending and receiving communication signals on a network including a wireless network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, Global System for Mobile Communications (GSM), a Third Generation (3G) network, a Fourth Generation (4G) network, a satellite communications network, and other like communications systems. More generally, network 110 may include a Wide Area Network (WAN), a Local Area Network (LAN) and/or a Personal Area Network (PAN). Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminal 120 can communicate with the network 110 and with other devices on the network 110 by sending and receiving wireless signals via the base station 130, which may also comprise local area, and/or personal area access points. The terminal 120 is shown being in communication with a global positioning system (GPS) 140 satellite, global navigation satellite system (GNSS) or the like, for position sensing and determination.

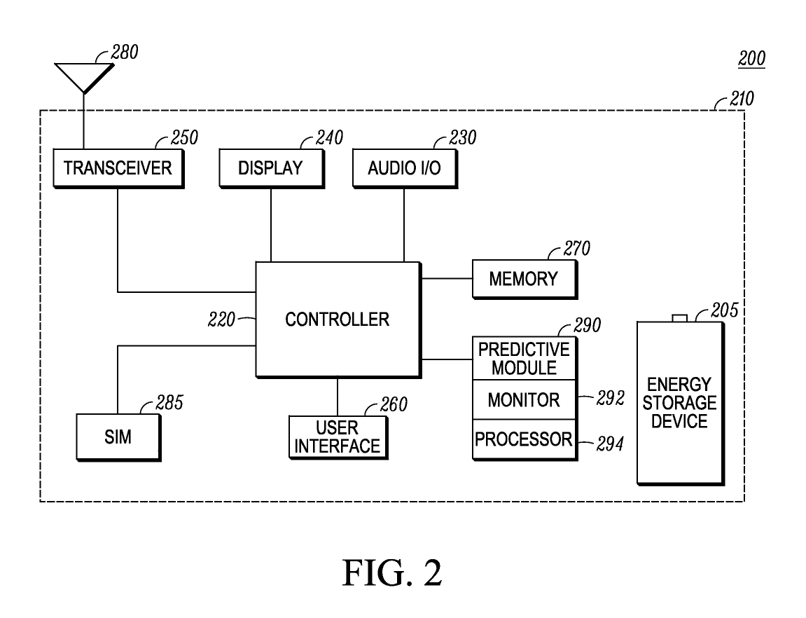

FIG. 2 is an exemplary block diagram of a wireless communication device 200 configured with an energy storage device, battery or module 205, such as in the terminal 120, for example. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a removable subscriber module 285 coupled to the controller 220.

As shown in FIG. 2, the wireless communication device 200 further includes a predictive power module 290 configured to: determine an expected time to a next charge; provide a program that correlates typical user usage and the determined time to the next charge, to calculate if an energy storage device of a wireless communication device will last to the next charge; and prompt a user with options to minimize power drain based on the calculation. The predictive module 290 can include a monitor 292 and processor 294, as described in more detail below.

In one embodiment, the module 290 can reside within in the controller 220, can reside within the memory 270, can be an autonomous module, can be software, can be hardware, or can be in any other format useful for a module on a wireless communication device 200.

The display 240 can be a liquid crystal display (LCD), a light emitting diode (LED) display, a plasma display, a touch screen display or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch screen or pad, a joystick, an additional display, or any other device useful for providing an interface between a user and an electronic device. The memory 270 may include a random access memory, a read only memory, an optical memory or any other memory that can be coupled to a wireless communication device.

In more detail, the wireless communication device 200 shown in FIG. 2, can include: a housing 210; a controller 220 coupled to the housing 210, the controller 220 configured to control the operations of the wireless communication device, and to provide ancillary computing operations which may be unrelated to wireless communications such as audio or video processing, application processing, etc. Advantageously, the predictive module 290 can predict usage to better help manage battery life, as detailed herein.

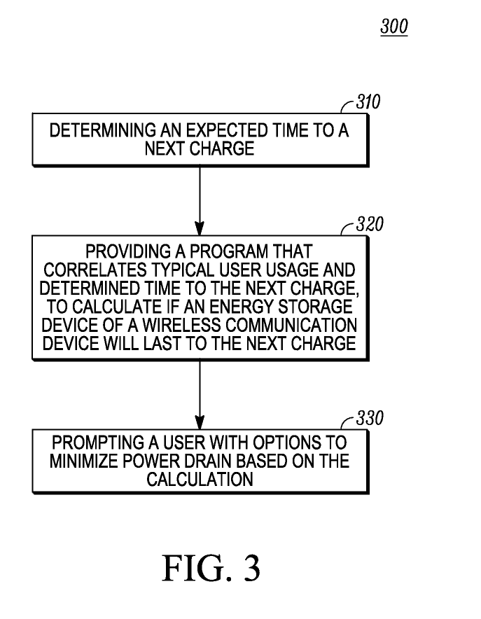

A block diagram of a wireless communication method with intelligent power management 300, is shown in FIG. 3. In its simplest form, the method 300 can include: determining 310 an expected time to a next charge; providing 320 a program that correlates typical user usage and determined time to the next charge, to calculate if an energy storage device of a wireless communication device will last to the next charge; and prompting 330 a user with options to minimize power drain based on the calculation. Advantageously, the method 300 can dramatically increase the useful life of a rechargeable battery or energy storage device, thus delaying the need for a charge, which users will welcome. Beneficially, an intelligent power management method is provided and adapted to provide personalized and reliable battery management information to a user.

Typical user usage can be based on past historical user activity stored in predictive module 290. Typical user usage can include information being predicted, based on calendar information, location, past usage, entered profile information, default information and the like. For example, in one embodiment, calendar information can be used to predict phone call usage, conference calls or communications that will need to be made, navigation needs, and the like for particular user, such as a business traveler. In one use case, a sensed location of a wireless communication device (phone) or calendar entry, can predict navigation needs, game usage while waiting in an airport and the like. If a battery is not expected to last to the next expected charge, a program can suggest usage options or recommendations that can result in extending battery life until the next charge. Options can include by way of example: disabling data, except for small duty cycle (for example, enable every 30 minutes to synch email); entering airplane mode and come out every 30 minutes to pull SMS or voicemail; disabling Bluetooth; lowering display brightness; modifying application processor speed; partially modifying navigation mode, to disable display between maneuvers; providing default profile; entering profile information to allow a user to set his or her own profile as to typical usage, such as to include business usage, student usage, media usage, power telephone user, gamer and the like.

In one use case, such as in a partially modified navigation mode, if a user is on a road for awhile, a disable or reduce GPS update rate can be set. For example, if a user is on US 101 for 20 miles in San Francisco, GPS can be partially disabled and only checked less frequently, such as once every minute. GPS update rate can be returned to normal when user is predicted to be near a maneuver.

In one embodiment, the providing step 320 includes indicating that the energy storage device will last to the next expected charge and displaying the time to or of the next expected charge. Beneficially, a user can adjust the expected charge time or usage needs, thereby potentially needing to take further measures to extend and manage the battery life.

In one embodiment, the providing step 320 can include indicating that the energy storage device will last to the next expected charge. The providing step 320 can include indicating an expected usage model. For example, the expected usage model can include a wireless communication device displaying and listing all of the predicted functions that will be used or typical user usage and minutes for each, based on stored historical information.

In more detail, in one embodiment, the typical user usage can include at least one of predicting a required application or applications based on a prior application(s) usage, providing a default setting and setting a use profile, input by a user for example. The prompting step 330 can include providing options to minimize power drain, to the next expected charge if in step 320 it is determined that the energy storage device will become depleted before the next expected charge. Some options can include disabling data, enabling airplane mode, reducing display brightness, restricting application processor speed, disabling display between navigation maneuvers, reducing GPS update rate, and the like.

In one embodiment, the method 300 can allow a user to program a reduced power draining mode. Beneficially, this feature allows a user to use a user interface to adjust the operation of the device to enable battery to last to the next expected charge.

In one embodiment, the method 300 can indicate that a wireless communication device is in a reduced power draining mode. This feature can allow a user to further program a device with additional power saving features or opt out of the reduced power draining mode.

In one embodiment, the method 300 can notify a user of at least one of: a predicted charging time and a predicted application usage. This feature can provide desired information to a user, for example.

The program can be loadable and customizable by a user, by at least one of downloading a software program, adjusting a setting and inputting information in a profile, for example. Advantageously, in one use case, a user can load an application through a USB connection, for example, or download a program to load on a wireless communication device. Similarly, upgrades and customizations can be loaded in any customary way.

In a preferred embodiment, the method 300 can include monitoring user activity and warning a user when a certain threshold activity has been met, that an energy storage device of a wireless communication device may not last to the next expected charge, and further allowing a user to adjust the wireless communication device to minimize power drain.

In a preferred embodiment, the program can include a heuristic predictive algorithm that collects, stores and aggregates historical information, such as typical user activity or usage and time to expected next energy storage device charge.

In one embodiment, the processor 294 includes a program that can include predicting future user activity and the next charge, based on historical information, such as user activity or usage stored in memory. The monitor 292 can monitor real time user activity and provide a warning to the user, that based on the activity to date, the energy storage device will not make it to the expected next charge. Advantageously, a user can then take appropriate measures, such as immediately recharging a battery, take power reduction action and the like.

In one embodiment, the program can include a heuristic predictive algorithm that collects and stores user activity or usage information and expected next charges, and can correlate user activity and charge times (or data aggregation). Correlating user activity and charge times, allows the program to learn and predict a user's typical user usage and charging habits, based on the collected, stored and aggregated user behavior. Advantageously, this information can help a user manage his or her battery, and provide more control of how the battery energy is utilized by the device.

In another embodiment, when a certain user activity threshold is reached or sensed by monitor 292, a user can be warned that the battery life to the expected next charge may be insufficient. The predictive module 290 can be programmed to automatically take immediate power reduction measures, by turning off or adjusting certain applications and functions, based on information programmed by a user or a profile set by a user, for example.

Advantageously, over time the program can provide power management intelligence based on stored historical data or as programmed by a user.

The user may initially indicate a certain profile that they feel is indicative of their expected usage. This can be used by the device while history is gathered to personalize the usage predictions. The different profiles could divide battery life among expected use cases. Some possible profiles include:

1. Media Hog: User consumes significant download media content. Streaming Media 120 Minutes, voice calls 15 minutes, 200 SMS, 30 minutes of browsing.
2. Fire Breathing Professional: User is on the phone and emails constantly throughout the day. Voice Calls 300 minutes, 400 SMS, 5 minutes of browsing
3. Gamer: 30 minutes of browsing, 15 minutes voice calls, 200 SMS, 180 minutes of gaming
4. Power Social Networker: 120 minutes browsing (Facebook, Twitter, etc), 800 SMS, 45 minutes voice calls.

The exact breakdown of time for functions would vary depending on the energy available in a battery. The user would be offered several preconfigured profiles to allow selection of a profile that is close to a user's expectations of how the device will be engaged.

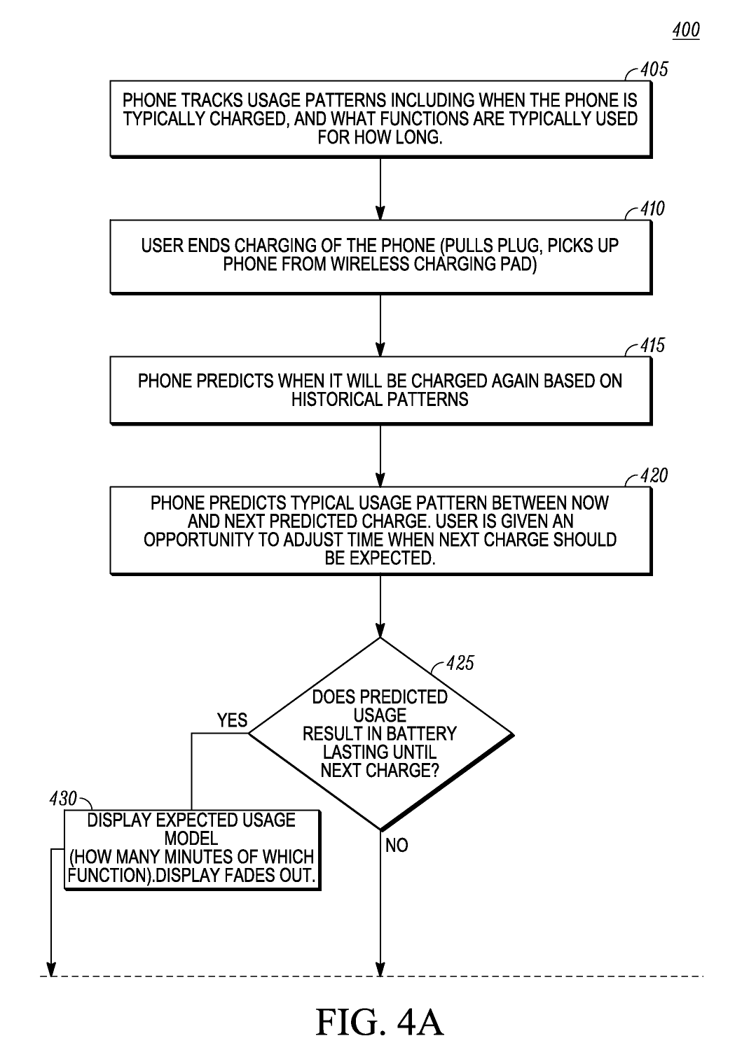

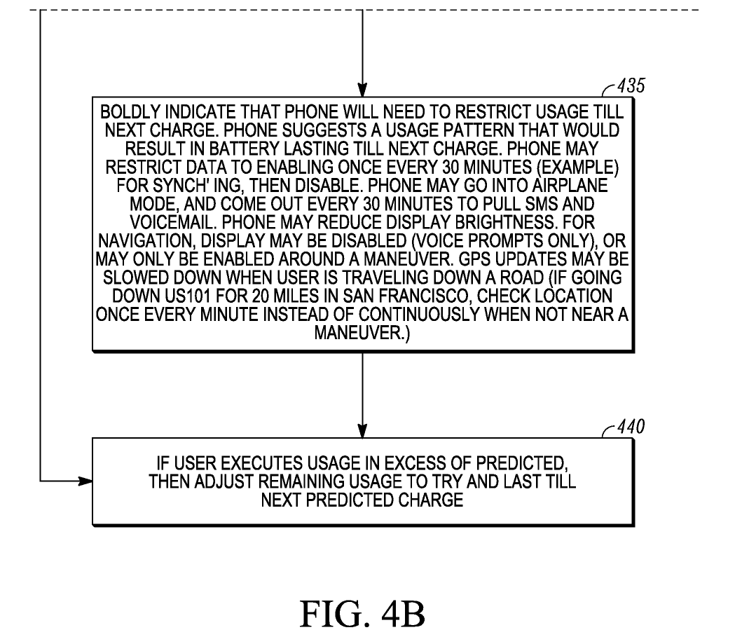

FIG. 4 is an exemplary flowchart 400 illustrating the operation of the predictive power module 290 and method 300, in one embodiment.

At 405, the flowchart begins by tracking usage patterns including when a phone is typically charged, and what functions and applications are typically used and for how long.

Next, at block 410 a user ends charging a device, such as a wireless communication device in the form of a phone, by for example disconnecting from a charging station or removing from a wireless charging pad.

Next, at block 415 the phone predicts when it will be charged again based on stored historical patterns, which can include past user activity, past charging time data and the like. This can be done preferably with a heuristic predictive algorithm, as detailed previously. If there are minimal or no historical patterns, the historical patterns can be provided by default settings and/or inputting profile information provided by a user, for example.

Next, at block 420 the device predicts typical user usage pattern between now and the next predicted charge. A user is given an opportunity to adjust the time when the next charge should be expected, via a user interface.

Next, decision diamond 425 is reached, and the inquiry is: Does the predicted usage result in a battery lasting until the next charge? If “yes”, the flowchart proceeds to block 430 and if “no”, to block 435.

In the event the answer is “yes”, at block 430, a display can show an expected usage model, such as a list of predicted functions, applications and the like and how many minutes for each. Advantageously, this provides the user with some intelligence and reinforcement that if he or she follows this typical user usage or behavior, the battery will last to the next expected charge. The display fades out after a short amount of time. An example of what might be shown is:

Texting 20 minutes;
Phone Calls 60 minutes;
Gaming 30 minutes,
Browsing 15 minutes,
Navigating 20 minutes,
Next Charge at 9 pm tonight (or 12 hours).

When the user stops charging his phone he will be shown what functions the device is expecting to support, and when the device is expecting to be charged next.

In the event the answer is “no”, the flowchart proceeds to block 435. As previously stated, if a battery is not expected to last to the next expected charge, a program can suggest usage options or recommendations that can result in extending battery life until the next charge. In one embodiment, a phone will display that that there is a need to restrict usage until the next charge. The phone can suggest a usage pattern that can minimize power drain and that can result in a battery lasting to the next charge. Other options and recommendations can include, by way of example, disabling data, except for small duty cycle (for example, enable every 30 minutes to synch, then disable); entering airplane mode and come out every 30 minutes to pull SMS or voicemail; lowering display brightness; modifying application processor speed; partially modifying navigation mode to disable display between maneuvers and the like. In a preferred embodiment, a list of these recommendations can be displayed and easily chosen, by use of a touch screen display, for example. Alternatively, certain options can be chosen automatically, by being previously programmed by a user.

Next, at block 440, in the event a user executes usage in excess of the predicted typical user usage, advantageously, a user can manually adjusts the remaining usage to minimize power drain, to try to have the battery last until the next expected charge.

This can be done automatically when a certain threshold activity is sensed or monitored, by being programmed by a user.

When a user is expecting to travel, it is anticipated that the device will learn of the impending trip from a calendar application, email residing on the device or by other means, and then consider reserving additional power for navigation, enabling a traveling businessman to navigate to his hotel after arriving. If the businessman is stuck in the airport and starts playing games to pass the time, the device may request the user to charge the device or discontinue the gaming if the gaming exceeds the usage profile previously communicated to the user.

Advantageously, this method allows a user to actively, manually or automatically, and intelligently manage power drain of an energy storage device (battery).

The device 200 and method 300 are preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments.

For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure. In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A wireless communication method, comprising:
determining an expected time to a next charge;
providing a program that correlates typical user usage and determined time to the next charge, to calculate if an energy storage device of a wireless communication device will last to the next charge; and
prompting a user with options to minimize power drain based on the calculation.

2. The wireless communication method of claim 1, wherein the providing step includes indicating that the energy storage device will last to the next expected charge.

3. The wireless communication method of claim 1, wherein the providing step includes indicating an expected usage model.

4. The wireless communication method of claim 1, wherein the providing step includes indicating that the energy storage device will last to the next expected charge and displaying the time till or of the next expected charge.

5. The wireless communication method of claim 1, wherein the typical user usage includes at least one of predicting a required application based on a prior application usage, providing a default setting and setting a use profile.

6. The wireless communication method of claim 1, wherein the options to minimize power drain to the next expected charge include at least one of: disabling data; enabling airplane mode; reducing display brightness; restricting application processor speed; disabling display between navigation maneuvers; and reducing GPS update rate.

7. The wireless communication method of claim 1, further comprising allowing a user to program a reduced power draining mode.

8. The wireless communication method of claim 1, further comprising indicating that a wireless communication device is in a reduced power draining mode.

9. The wireless communication method of claim 1, further comprising notifying the user of at least one of: a predicted charging time and a predicted application usage.

10. The wireless communication method of claim 1, wherein the program is loadable, upgradeable and customizable.

11. The wireless communication method of claim 1, wherein the provided program includes a heuristic predictive algorithm that collects typical user activity.

12. The wireless communication method of claim 1, wherein the provided program includes monitoring user activity and warning a user when a certain threshold activity has been met, that an energy storage device of a wireless communication device may not last to the next expected charge.

13. The wireless communication method of claim 1, wherein the provided program includes monitoring user activity and warning a user when a certain threshold activity has been met, that an energy storage device of a wireless communication device may not last to the next expected charge, and further allowing a user to adjust the wireless communication device to minimize power drain.

14. A wireless communication device, comprising:
a housing;
a controller coupled to the housing, the controller configured to control the operations of a wireless communication device; and
a predictive power module configured to: determine an expected time to a next charge; provide a program that correlates typical user usage and the determined time to the next charge, to calculate if an energy storage device of a wireless communication device will last to the next charge; and prompt a user with options to minimize power drain based on the calculation.

14. The wireless communication device of claim 13, wherein the predictive power module is configured to include indicating an expected usage model.

15. The wireless communication device of claim 13, wherein the predictive power module is configured to display options to minimize power drain to the next expected charge.

16. The wireless communication device of claim 13, wherein the predictive power module is configured to allow a user to program a reduced power draining mode.

17. The wireless communication device of claim 13, wherein the predictive power module is configured to indicate that a wireless communication device is in a reduced power draining mode or not.

18. The wireless communication device of claim 13, wherein the predictive power module is configured with a program that is loadable and customizable by a user.

19. The wireless communication device of claim 13, wherein the predictive power module is configured with a program including monitoring user activity and warning a user when a certain threshold activity has been met, that an energy storage device of a wireless communication device may not last to the next expected charge.
